(19) United States
(12) Patent Application Publication
(10) Pub. No.: US 2014/0156763 A1
(43) Pub. Date: Jun. 5, 2014

(54) PERSON CENTRIC FEEDS AND DIRECT MESSAGING IN BUSINESS SYSTEMS

(71) Applicants: Steffen Dubetz, Speyer (DE); Ralf Missal, Ilvesheim (DE); Daniela Schlaud, Sandhausen (DE); Bertram Wiest, Heidelberg (DE); Gerald Reinhard, Schwetzingen (DE); Joachim Foerderer, Wiesloch (DE)

(72) Inventors: Steffen Dubetz, Speyer (DE); Ralf Missal, Ilvesheim (DE); Daniela Schlaud, Sandhausen (DE); Bertram Wiest, Heidelberg (DE); Gerald Reinhard, Schwetzingen (DE); Joachim Foerderer, Wiesloch (DE)

(21) Appl. No.: 13/706,114

(22) Filed: Dec. 5, 2012

(51) Int. Cl. G06Q 10/10

(52) U.S. Cl. CPC G06Q 10/107
USPC 709/206

(57) ABSTRACT

Embodiments of the present disclosure may provide a system and method for generating feeds and direct messaging in business systems. Generating a feed in a business system may include subscribing to a user, determining content associated with the subscribed user that is relevant for the feed and monitoring for changes to the content determined to be relevant for the feed. A determination may be made to determine which of the changes to the content determined to be relevant for the feed to include in the feed. A notification can be generated about the changes in the feed.

### BACKGROUND

Efficient and reliable communication systems are critical for the success of a business. Such communication systems should allow for real time communication and contribute to the user's collaboration efforts such that quick and effective business decisions can be made.

Examples of systems used for real-time communication are web feeds and direct messaging. Web feeds are used to provide users with information in real-time about frequently updated information. RSS feed is an example of a feed used to update current news items in a summarized format so that users can chose the news items that are of interest to them.

Direct messaging provides for instantaneous transmission of text-based messages from a sender to a receiver. An advantage that direct messaging provides over e-mail services is that it allows an immediate receipt of acknowledgment or reply to be sent to the sender. Unlike web feeds which are unidirectional notifications, direct messaging allow bi-directional communication in real-time.

Although web feeds and direct messaging have been widely used in social networks and have been integrated into email clients, feeds and direct messaging have not been integrated into business systems to provide efficient real-time collaboration between users of the business systems.

### BRIEF DESCRIPTION OF THE DRAWINGS

The accompanying drawings illustrate the various embodiments and, together with the description, further serve to explain the principles of the disclosed embodiments and to enable one skilled in the pertinent art to make and use the embodiments.

FIG. 1 illustrates an embodiment of a process for generating a feed.

FIG. 2 illustrates a feed delivery mechanism according to an embodiment of the present disclosure.

FIG. 3 illustrates a feed delivery mechanism according to another embodiment of the present disclosure.

FIG. 4 illustrates an exemplary feed according to an embodiment of the present disclosure.

FIG. 5 illustrates an embodiment of a process for generating a direct message in a business system.

FIG. 6 is a block diagram of an exemplary computer system.

### DETAILED DESCRIPTION

Embodiments of the present disclosure may provide a system and method for generating person centric feeds and direct messaging in business systems. Generating a feed in a business system may include subscribing to a user, determining content associated with the subscribed user that is relevant for the feed and monitoring for changes to the content determined to be relevant for the feed. A determination may be made to determine which of the changes to the content determined to be relevant for the feed to include in the feed. A notification can be generated about the changes in the feed.

Generating a direct message in a business system may include providing a user interface to enter message content for the direct message and one or more recipients of the direct message and sending the direct message to the one or more recipients. The direct message may be linked to a business object. The direct message may be linked to a business object associated with the message content, a business object selected by a user or a business object included in the message content.

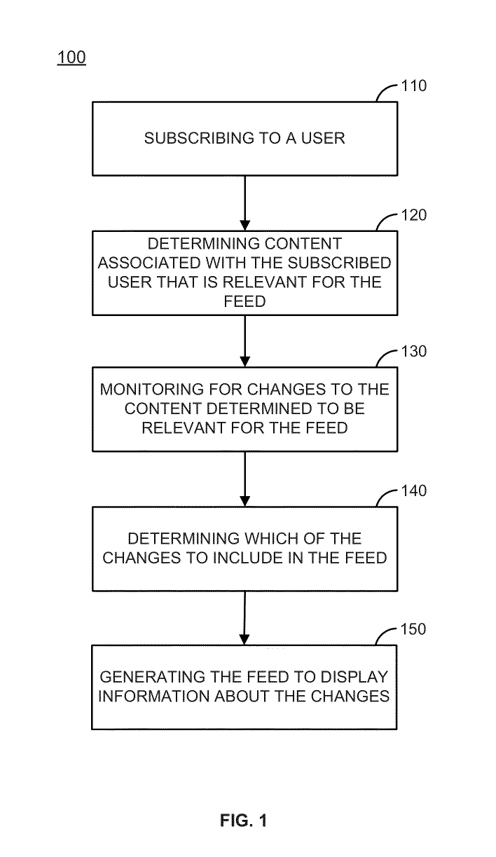

FIG. 1 illustrates an embodiment of a process 100 for generating a feed. The process 100 may be performed by a server system having one or more process and memory storing one or more programs having instructions for process 100. The process may be used in a business environment to inform users about relevant changes to certain objects in the systems. The process may include subscribing to a user to another user 110, determining content associated with the subscribed user that is relevant for the feed 120, monitoring for changes to the content determined to be relevant for the feed 130, determining which of the changes to include in the feed 140, and generating the feed to display information about the changes 150.

Subscribing to a user 110 may include selecting one or more users for a user to follow. Subscribing may include selecting a group type corresponding to users that belong to a particular organization (e.g., sales, marketing or personnel management) or users that are responsible for certain tasks (e.g., placing orders, creating business objects or testing business objects). If a group is selected, then all of the users belonging to the group may be included in the subscription. The subscribing may be performed unidirectionally, such that if user A subscribes to user B, user B does not subscribe to user A. Similarly, if user A subscribes to a group, then all of the users in the group do not automatically subscribe to the user A.

Options for selecting a user to follow may be limited. The user making the selection may be limited to select users which are in his group or may be limited to users which share the same level of access to information in the collaborative business environment. The selection may also require approval by an administrator or by the user that is selected to be followed. The user selected to be followed may receive a notification that he is being followed or a request to be followed.

Each user may have associated content that is of interest to other users in the collaborative business environment. The content may include information about the user or information about tasks performed by the user. The content may be certain business objects within a business system. The content may include user profile information (e.g., name, contact information or job title), information related to an activity, or information related to a business object. The content that is associated with a user may be content to which the subscribed user has access, content to which the subscribed user can make changes, or content of which the subscribed user is the owner.

Determining content associated with the subscribed user that is relevant for the feed 120 may be performed because all of the content associated with a user that is being followed may not be relevant for the feed. For example, some of the content that is associated with the user may not be needed by other users in the collaborative business environment. The determination may be performed automatically without the user having to manually select which content is relevant for the feed. The determination may be made automatically based on the user settings, settings in the business environment, or information used by applications (e.g., application used by the user receiving the feed).

The content that is determined relevant for the feed 120, may be monitored for changes 130. The monitoring may include monitoring changes that the subscribed user makes to content associated with the subscribed user. The monitoring may include detecting changes to the content determined to be relevant for the feed. The changes may include changes in the user's profile data (e.g., new e-mail address, new picture or new job title), the status of a task, business object or content of a file. The changes may also include creation of a new objective, a new activity, or a business object.

The changes to the content associated with the subscribed user, do not have to be changes that are performed by the subscribed user. The changes can be made to the content by other users that may or may not be subscribed users. Thus, the feed may include information about changes in the content associated with a user without directly subscribing to the specific content. Subscribing to the user having the content can automatically include the content and the changes to the content that are relevant in the feed.

By monitoring the changes to the content associated with a subscribed user, the process allows for the feed to follow the behavior of the subscribed user and/or the usage of the system. The feed can provide the details about changes that the user makes to content associated with his use of the system and changes made by other users to the subscribed user's information or information used by the subscribed users.

In step 140, it may be determined which of the monitored changes to include in the feed. The determination may be made because not all of the changes may be relevant to the user. For example, minor changes in the event (e.g., change to event completion from 1:00 pm to 2:00 pm) may not be relevant for the feed. However, other changes such as canceling an event may be relevant for the feed. The determination as to which changes to include in the feed may be made automatically based on the type of content in which the changes are made, user settings, settings in the business environment, or information used by applications (e.g., application used by the user receiving the feed).

Business objects that may be relevant for the feed may include professional profile, performance and development activity, employee objective, or feed event subscriptions. The relevant changes in the professional profile may include changes in job title, photo, about me details, professional summary, career aspiration, expertise, language, work experience, achievement, education, mentoring skill, website address, or contact information. Changes in the performance and development activity may include creation of public activity, change status of activity to public, name changes, description changes, adding attachments, adding links, adding comments, setting status to finished, and setting status to in process. The employee objective changes may include creating an objective, changing status of objective to public, changing the name, changing the description, setting status to “completed,” setting status to “in process” or setting status to “assigned” or “reassigned.” Feed event subscription may include new instance to follow a profile.

The determination of which objects or changes to include (steps 120 and 140) may include determining if the content is public. If the content is not public or if the changes made would make previously public content private, then the content and/or the change can be determined to be not relevant for the feed. Details about a change to content that was previously private and is made public by the change may be included in the feed.

The changes determined to be included in the feed may be included in the feed by generating information about the changes 150. The information may include one or more of the users who made the change, the subscribed user to whom the content is associated, link to the content that is changed and details about the change (e.g., type of change, time of change and time when object having the change was created). The information in the feed may be text based with optional attachments (e.g., documents, links, photos or videos).

The feed may also include status update feeds about subscribed users or other users in the system. The status update feeds may be manually created by the user or automatically generated based on users schedule and/or activities.

A user receiving the feed may be provided with an option to include a comment on the information in the feed or reply to the feed. The comment may be provided only to the user receiving the feed as a note about the information in the feed. The comment may be sent as a notification (e.g., e-mail message or direct message) to the subscribed user, the user making the change to the object or to users subscribing to the content associated with the change. The reply message may be sent to the subscribed user associated with the feed message, to all users subscribing to the user making the reply or to all of the users who received the original feed to which a reply is posted.

The user receiving the feed may have an option to unsubscribe from the subscribed user or from one or more of the content associated with the subscribed user. The user receiving the feed may have an option to unsubscribe from the subscribed user but continue to receive notifications about content changes that were previously associated with the subscribed user (e.g., continue to receive information in the feed about changes to sales data previously associated with a subscribed user).

The user receiving the feed may also have an option to subscribe to relevant information which are associated with an application but are not associated with the subscribed user. For example, the user may subscribe to a creation of new objects that is not associated with the subscribed user. The user may also have an option to subscribe to objects created by the subscribed user and receive feed relevant information about the object.

A feed event type may be maintained for the content that can be changed by the one or more users. The feed event type may be used to determine which content changes are feed relevant.

In an alternative embodiment of the method shown in FIG. 1, the changes to the content may be monitored and the owner of the changed content and/or the person performing the change may be determined such that the change can be associated with the owner. The change can be included in the feed of users who subscribe to the owner of the changed content or the person performing the change.

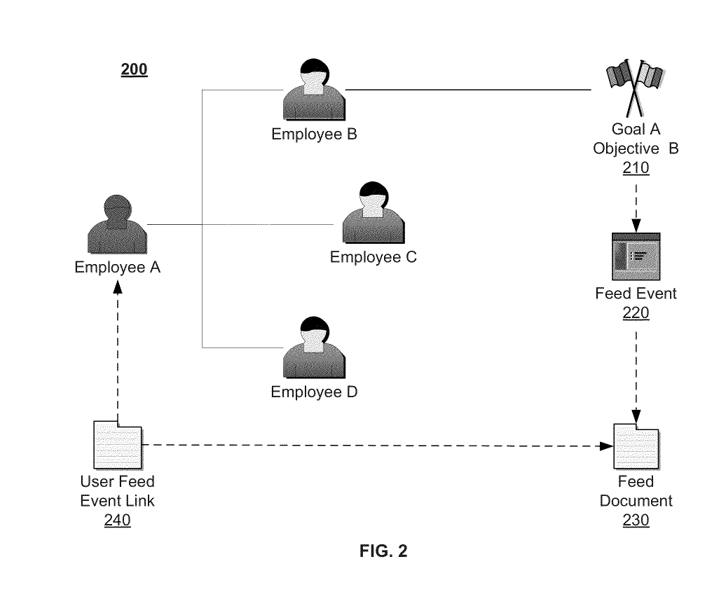

FIG. 2 illustrates a feed delivery mechanism 200 according to an embodiment of the present disclosure. Employee A may follow Employee B, Employee C and Employee D. Employee A may receive a feed if a new object is introduced which is related to one or more of Employee B, Employee C and Employee D. For example, Employee B may create a new goal and/or a new objective 210 (e.g., create new business object). The creation of the new goal and/or the new objective 210 may be determined to be feed relevant and designated as a feed event 220. The feed event 220 may be a business object which includes the information about the new goal and/or the new objective 210. The feed event 220 may include additional administrative data about the new goal and/or the new objective 210. A new feed document 230 may be created once the new goal and/or the new objective 210 is determined to be feed relevant. The feed document 230 may be created based on the feed event 220. All of the employees (e.g., Employee A) which are linked to the employee responsible for the creation of the new goal and/or the new objective 210 may be linked to the feed document 230 by a user feed event link 240.

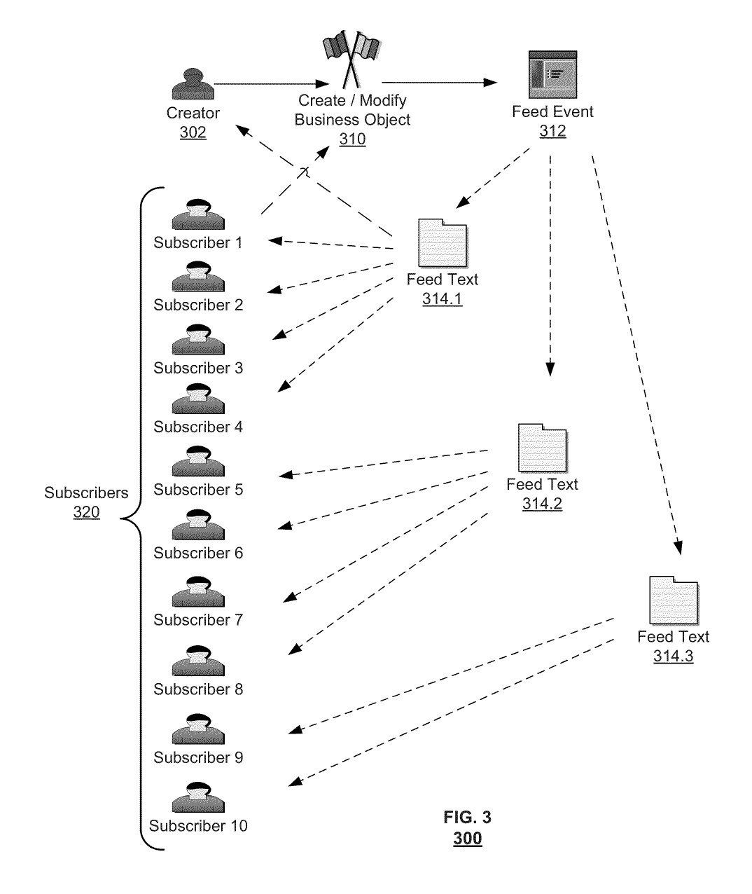

FIG. 3 illustrates a feed delivery mechanism 300 according to another embodiment of the present disclosure. As shown in FIG. 3, in a system with three supported system languages and one creator 302 creating the business object 310 for ten subscribers 320, one feed event may be used to create three separate feed texts 314.1-3. The feed texts 314.1-3 may be provided to the users based on eleven feed subscriptions (ten for the subscribers 320 and one for the creator 302). The creation of the feed event 312 may be independent of subscribers 320 subscribing to the business object or the creator 302.

As shown in FIG. 3, a creator 302 may create and/or modify a business object 310. The creator 302 may issue a request that is received by the system to create and/or modify the business object 310. The creation and/or modification of the business object 310 may include creation and/or modification of a public objective. The creation of the business object 310 or a particular modification of the business object 310 may be marked by the creator 302, administrator, or customer as being feed relevant. The creation and/or certain modifications of the business object 310 may be automatically designated as being feed relevant based on preset settings by the creator 302, administrator or customer. A notification may be received by the system indicating that the modification of the business object is a feed relevant modification. The feed relevant information may include creation and/or modification of the public objective.

The feed relevant information may be used to generate a feed event 312. The generation of the feed event 312 may be independent of subscribers subscribing to the feed event 312 or to the business object 310. The feed event 312 may be generated based on the feed relevant modification. The feed event 312 may be a business object which includes the before and/or after image of the business object 310 which is created, changed or deleted. The feed event 312 may include administrative data (e.g., identity of creator or when change was made, but is not so limited). The feed event 312 may be created synchronously with the creation and/or modification of the business object 310.

The feed event 312 may be used to generate the feed text and/or feed subscription 314.1-3. The creation of the feed text and/or feed subscription 314.1-3 may be performed after the feed event 312 is generated. The feed text and/or feed subscriptions 314.1-3 may be generated only based on the information in the feed event 312. Thus, the feed text and/or feed subscription 314.1-3 may be generated asynchronously with the creation of the feed event 312 and do not have to be directly related to the business object 310.

The feed text 314.1-3 may be created by reading the information in the feed event 312 and creating the text for the feed text 314.1-3 which is readable by the one or more of the subscribers 320 and/or the creator 302. The text for each of the feed text 314.1-3 may be created in a system language supported by the particular feed text 314.1-3. Each of the feed text 314.1-3 may support a different system language.

The feed subscription of the feed text 314.1-3 may be created by reading the information in the feed event 312 and linking the feed text 314.1-3 to one or more of the subscribers 320 and creator 302. A different feed subscription may be created for each of the subscribers 320 and/or for each of the feed text 314.1-3. The feed subscription may be generated based on the system language supported by the particular feed text 314.1-3 and the system language supported by the subscribers 320 and creator 302. As shown in FIG. 3, the feed text 314.1 may be provided to one or more of the creator 302 and subscribers 1-4. The feed text 314.2 may be provided to the one or more of the subscribers 5-8. The feed text 314.3 may be provided to subscriber 9 and/or subscriber 10.

One or more of the subscribers 320 may modify the business object 310 and information about the modification may be provided in the feed text 314.1-3 via the feed event 312. The system may be expanded to include multiple business objects and multiple feed events that are used to create feed text for the subscribers 320 and/or creator 302.

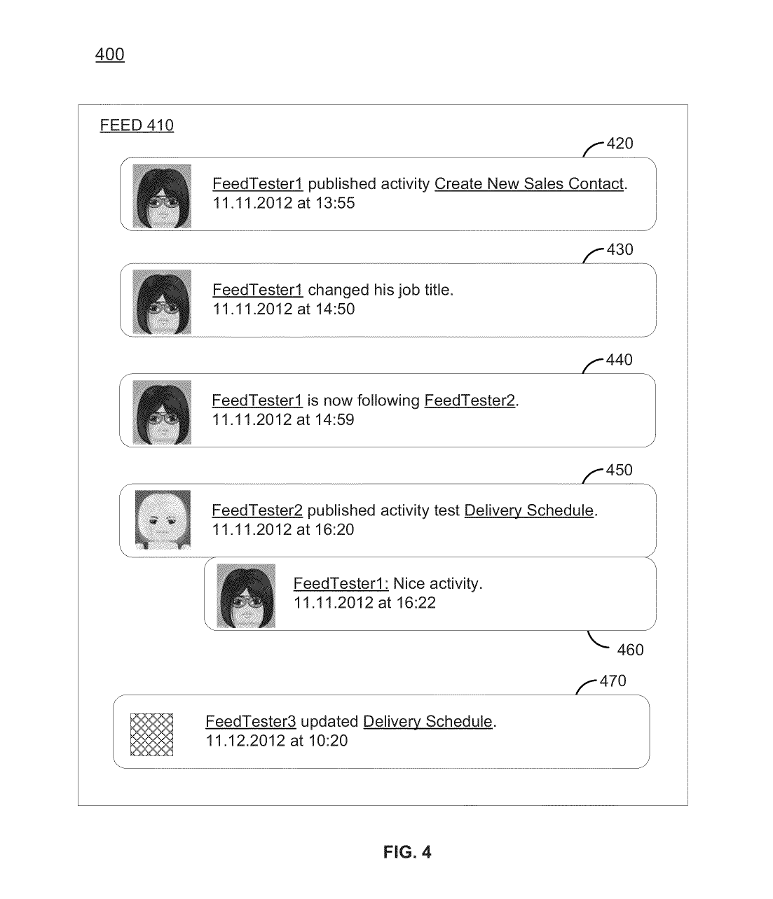

FIG. 4 illustrates an exemplary feed 400 according to an embodiment of the present disclosure. The feed may include a number of notifications 420-470 including information about changes to content associated with subscribed users. The number of notifications can be provided on a profile page of the user or on a home screen of the user. Subscribed users can include FeedTester1 and FeedTester2. Not subscribed users can include FeedTester3.

The feed may include notifications 420, 450 and 470 that include text with changes to a business object. A link may be provided to the business object in the notifications. The notification itself may be linked to the business object or the user, such that clicking on the notification would direct the user to the profile of the user in the notification or the business object included in the notification. Notification 430 may provide details about content changes without including a link to the business object. Everyone that receives the feed may comment or respond to the feed with notification 460. The feed may include a notification 470 of changes made by a user that is not a subscribed user (FeedTester3) to content associated with subscribed users (FeedTester1).

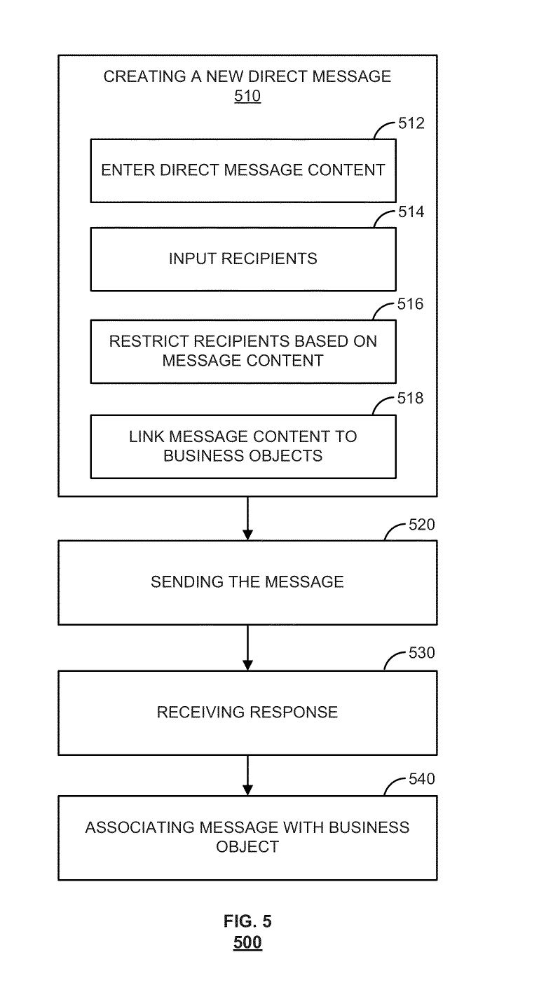

FIG. 5 illustrates an embodiment of a process 500 for generating a direct message in a business system. The process 500 may include creating a new direct message 510, sending the message 520, receiving a response 530, and associating message with a business object 540. Creating the new direct message 510 may include entering direct message content 512, inputting recipients 514, restricting recipients based on message content 516 and linking message content to business objects 518.

The direct messaging in the business systems can be customizable allowing the customer to configure the direct communications between users associated with a certain business object and/or processes, social and/or business relationship, or certain organizational entities (e.g., sub companies or countries). The direct messaging may be configured, administered and managed either centrally or by line-of-business according to companies needs and/or guidelines. The direct messages may be associated with business objects. Thus, the direct messages can be combined with business object data which may be part of business processes such as marking, purchasing, human capital management or performance management.

The direct message may be used to send messages in a collaborative business environment. Each user may have a message inbox and a message outbox for the direct messaging. The direct message can be sent from the users outbox to the other user's inbox. The mainframe or the shell of the user interface or the home screen may include links to the messaging functionality. When a new direct message is received, a number indicator may be provided next to the links to the messaging functionality. Clicking on the number indicator may display the message. The message may also be automatically displayed in the user interface when the message is received.

A user may enter the direct message content 512 from a user interface within the business system. The content may include one or more of text, video, audio file, links, attachments, calendar contacts or events, images or e-mails. The direct message may be edited in rich-text.

Inputting the recipients 514 of the direct message may include a user selecting one or multiple users to receive a message or may include selecting a defined group of users. The user may select the users to receive the message via a name-sensitive input field which searches for users or defined groups in real-time during typing.

The defined group of users may be users that are associated with a certain business object, certain business processes, social and/or business relationship, or certain organizational entities (e.g., sub companies or countries). The social and/or business relationship may depend on their function, job title, organization relationship or users being followed (e.g., user followed for a person centric feed). The group of users that will receive the message may be automatically generated based on the business processes or the business object that is included in the message. For example, if the message includes details about Sales Objective A, then all of the users that are associated with the Sales Objective A may be included as the recipients of the message. In another embodiment, the users or groups that are associated with the object included in the message may be provided as potential recipients of the message and the user may select which of the potential recipients should receive the message.

The input recipients may be restricted based on the content of the direct message 516. The restriction may be based on the business object included in the direct message or the association of the message content to one or more business objects. Thus, if a user who is not allowed access to a business object that is associated with the message is entered as a recipient, the user who is not allowed access may be removed automatically or a notification can be provided to the direct message creator about the restriction. The input recipients may be restricted at the time of entering the recipients 514 by restricting what users can be entered as the recipients of the message based on the content of the message. The restriction may also be applied after the message content is entered, if the message content is entered after the recipients are selected.

The message content may be linked to one or more business objects 518. Links may be provided in the text of the message content to business objects associated with the text. The links may be associated with a portion of the message content. Links to the referenced business objects in the message can be automatically created in the message. For example, the links can be automatically created if the direct message content references a business object. The direct message may also support metadata tags (e.g., hashtags) for grouping and filtering messages based on keywords.

The user may be provided with an option to send the message 520 after it is created. The message may also be sent automatically as soon as a portion of the text is entered or while the text is being entered. The sent direct message may include the title, abstract and sender of the message. Links may be included in the direct message to allow direct navigation to the respective senders profile and/or the complete message. A notification about the direct message may be sent via another communication method such as an e-mail, short message service (SMS) or push notification. The user may receive the additional notification based on the user's notification settings. The notification may include a notice that a new message has been received or the content of the direct message.

Once a recipient receives a message, the recipient may respond to the message and a response may be sent to the sender 530. Sending the response may include all of the options provided to the original direct message. The recipient may reply to the original sender, all of the recipients of the original direct message or to one or more of the recipients.

Associating the message with the business object 540 may include associating one or more business objects with the direct message and/or the responses based on the content of the message or manually based on user selections. The direct message or the whole conversation including the responses to the direct message may be exported as a file with a textual format (e.g., portable document format (PDF)). The exported file may be attached to other business objects in the business system. In another embodiment, the direct message or the whole conversation may be stored and the reference to the stored location of the message may be associated with or linked to one or more business objects. The conversations based on the direct messages can enhance other business objects (e.g., goals, activities, tasks, purchase orders or contrast) by including or associating the content of the direct message with the business object.

The direct messaging in a business system may be integrated into a company's IT infrastructure. Integration into the companies IT infrastructure may allow a user to send and receive e-mails, attachments, tasks and calendar items via the direct messaging. The direct message may also be sent to various devices connected to the company's IT infrastructure (e.g., smartphones, terminals, computer, phones) via the business system.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the disclosure may be implemented using Java, C++, or other object-oriented programming language and development tools. Another embodiment of the disclosure may be implemented in hard-wired circuitry in place of, or in combination with machine readable software instructions.

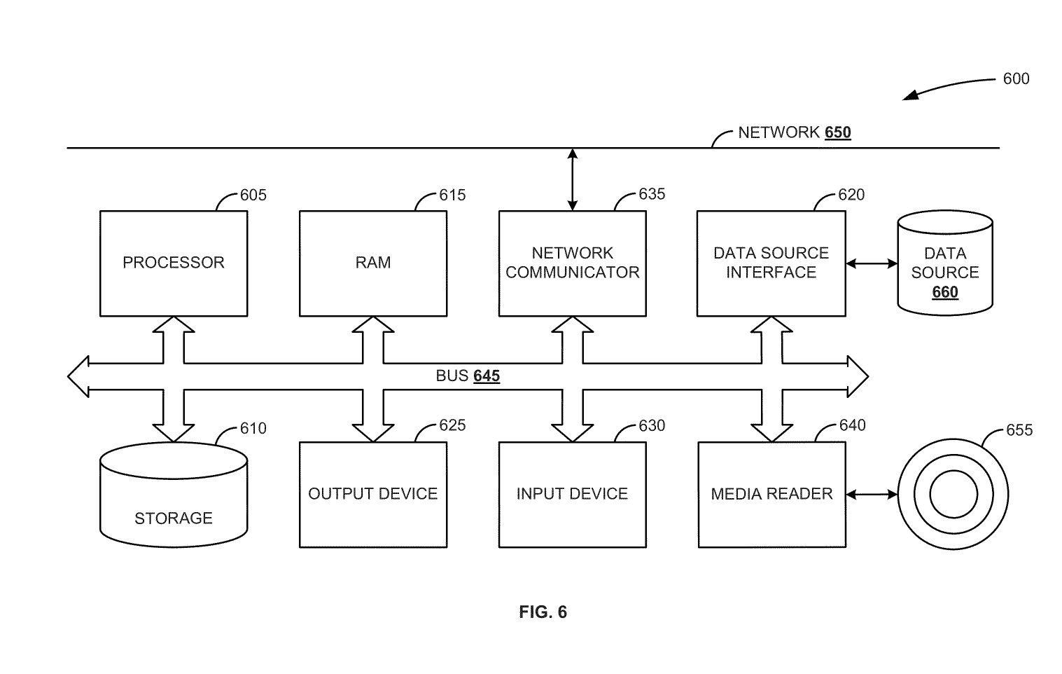

FIG. 6 is a block diagram of an exemplary computer system 600. The computer system 600 includes a processor 605 that executes software instructions or code stored on a computer readable storage medium 655 to perform the above-illustrated methods of the disclosure. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. The stored instructions may be further compiled to generate other representations of the instructions and dynamically stored in the RAM 615. The processor 605 reads instructions from the RAM 615 and performs actions as instructed. According to one embodiment of the disclosure, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed by network 650. In some embodiments the data source 660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

A semantic layer is an abstraction overlying one or more data sources. It removes the need for a user to master the various subtleties of existing query languages when writing queries. The provided abstraction includes metadata description of the data sources. The metadata can include terms meaningful for a user in place of the logical or physical descriptions used by the data source. For example, common business terms in place of table and column names. These terms can be localized and or domain specific. The layer may include logic associated with the underlying data allowing it to automatically formulate queries for execution against the underlying data sources. The logic includes connection to, structure for, and aspects of the data sources. Some semantic layers can be published, so that it can be shared by many clients and users. Some semantic layers implement security at a granularity corresponding to the underlying data sources' structure or at the semantic layer. The specific forms of semantic layers includes data model objects that describe the underlying data source and define dimensions, attributes and measures with the underlying data. The objects can represent relationships between dimension members, provides calculations associated with the underlying data.

In the above description, numerous specific details are set forth to provide a thorough understanding of embodiments of the disclosure. One skilled in the relevant art will recognize, however that the various embodiments can be practiced without one or more of the specific details or with other methods, components, techniques, etc. In other instances, well-known operations or structures are not shown or described in details to avoid obscuring aspects of the disclosure.

Although the processes illustrated and described herein include series of steps, it will be appreciated that the different embodiments of the present disclosure are not limited by the illustrated ordering of steps, as some steps may occur in different orders, some concurrently with other steps apart from that shown and described herein. In addition, not all illustrated steps may be required to implement a methodology in accordance with the present disclosure. Moreover, it will be appreciated that the processes may be implemented in association with the apparatus and systems illustrated and described herein as well as in association with other systems not illustrated.

The above descriptions and illustrations of embodiments of the disclosure, including what is described in the Abstract, is not intended to be exhaustive or to limit the embodiments to the precise forms disclosed. While specific embodiments of, and examples for, the embodiments are described herein for illustrative purposes, various equivalent modifications are possible within the scope of the disclosure, as those skilled in the relevant art will recognize. These modifications can be made to the embodiments in light of the above detailed description. Rather, the scope of the disclosure is to be determined by the following claims, which are to be interpreted in accordance with established doctrines of claim construction.

We claim:

1. A non-transitory computer readable storage medium storing one or more programs configured to be executed by a processor, the one or more programs comprising instructions for:
receiving a request to modify a business object;
receiving a notification that the request to modify the business object is a feed relevant modification;
generating a feed event based on the feed relevant modification;
generating a first feed text in a first system language based on information in the feed event;
generating a second feed text in a second system language which is different from the first system language based on the information in the feed event;
generating a first subscription to link the first feed text to one or more subscribers; and
generating a second subscription to link the second feed text to one or more subscribers.

2. The computer readable storage medium of claim 1, wherein the request to modify the business object is a request to create the business objective.

3. The computer readable storage medium of claim 1, wherein the feed event is a business object which includes information about the request to modify the business object and administrative data.

4. A method for generating a feed in a business system, the method comprising:
subscribing a user to a subscribed user;
determining content associated with the subscribed user that is relevant for the feed;
monitoring for changes to the content determined to be relevant for the feed;
determining which of the changes to include in the feed;
generating a notification about the changes in the feed; and
providing the notification to the subscribed user.

5. The method of claim 4, further comprising generating a link to a business objects reference included in the notification about the changes.

6. The method of claim 4, further comprising providing the feed in a plurality of user interfaces belonging to users subscribing to the subscribed user.

7. The method of claim 4, wherein the subscribed user is not subscribed to one or more users following the subscribed user.

8. The method of claim 4, wherein the changes to the content are changes that are made by a user that is not a subscribed user.

9. The method of claim 4, wherein subscribing to the user includes:
displaying a list of users that can be subscribed based on the level of access the user making the selection has to the business objects in the business system; and
selecting one or more of the displayed users to be subscribed users.

10. The method of claim 4, wherein determining content associated with the subscribed user that is relevant for the feed includes determining the content associated with the subscribed user to which the user receiving the feed has access.

11. The method of claim 4, wherein determining content associated with the subscribed user that is relevant for the feed is made based on selections made by the subscribed user.

12. A non-transitory computer readable storage medium storing one or more programs configured to be executed by a processor, the one or more programs comprising instructions for:
subscribing a user to a subscribed user;
determining content associated with the subscribed user that is relevant for the feed;
monitoring for changes to the content determined to be relevant for the feed;
determining which of the changes to include in the feed;
generating a notification about the changes in the feed; and
providing the notification to the subscribed user.

13. The non-transitory computer readable storage medium of claim 12, further comprising generating a link to a business objects reference included in the notification about the changes.

14. The non-transitory computer readable storage medium of claim 12, further comprising providing the feed in a plurality of user interfaces belonging to users subscribing to the subscribed user.

15. The non-transitory computer readable storage medium of claim 12, wherein the subscribed user is not subscribed to one or more users following the subscribed user.

16. The non-transitory computer readable storage medium of claim 12, wherein the changes to the content are changes that are made by a user that is not a subscribed user.

17. The non-transitory computer readable storage medium of claim 12, wherein subscribing to the user includes:
displaying a list of users that can be subscribed based on the level of access the user making the selection has to the business objects in the business system; and
selecting one or more of the displayed users to be subscribed users.

18. The non-transitory computer readable storage medium of claim 12, wherein determining content associated with the subscribed user that is relevant for the feed includes determining the content associated with the subscribed user to which the user receiving the feed has access.

19. The non-transitory computer readable storage medium of claim 12, wherein determining content associated with the subscribed user that is relevant for the feed is made based on selections made by the subscribed user.
